(19) United States
(12) Patent Application Publication
(10) Pub. No.: US 2013/0322491 A1
(43) Pub. Date: Dec. 5, 2013

(54) WELDED THERMOCOUPLE TEST APPARATUS

(71) Applicants: HONG FU JIN PRECISION INDUSTRY (WUHAN) CO., LTD., Wuhan (CN); HON HAI PRECISION INDUSTRY CO ., LTD., New Taipei (TW)

(72) Inventors: ZHI-YONG GAO, Wuhan (CN); TING-TING WU, Wuhan (CN); YU-LIN LIU, Wuhan (CN)

(73) Assignees: HON HAI PRECISION INDUSTRY CO., LTD., New Taipei (TW); HONG FU JIN PRECISION INDUSTRY (WUHAN) CO., LTD., Wuhan (CN)

(21) Appl. No.: 13/862,596

(22) Filed: Apr. 15, 2013

(30) Foreign Application Priority Data
Jun. 5, 2012 (CN) 201210181915.8

(51) Int. Cl. G01K 7/02

(52) U.S. Cl. CPC G01K 7/02
USPC 374/179

(57) ABSTRACT

A test apparatus for welded thermocouple joints includes a signal selection circuit, a first comparison circuit, a second comparison circuit, a switch circuit, and an indication circuit. The signal selection circuit outputs either a first direct current (DC) voltage or a second DC voltage according to selection. The first comparison circuit compares the first DC voltage with a first reference voltage if a first DC voltage is received, to output a first control signal. The second comparison circuit compares the second DC voltage with a second reference voltage if a second DC voltage is received, to output a second control signal. The switch circuit receives either a first or a second control signal and outputs an indication accordingly. The indication circuit receives the indication, and warns the user that the joint has full integrity, that the joint has a short circuit, or that the joint is open circuit.

### BACKGROUND

1. Technical Field

The present disclosure relates to a test apparatus for testing whether a welded thermocouple is functioning and properly welded.

2. Description of Related Art

A thermocouple is a junction between two different metals that produces a voltage when heated. Thermocouples are widely used as a sensor for measuring temperature, and converting heat to electric signals, such as voltage. Thermocouples for real-time measurement of temperature are junctions of specific alloys which have a predictable and repeatable relationship between temperature and voltage. Different alloys are welded together by a special apparatus to form thermocouples. The thermocouples need to be tested for the integrity of the weld joint, for ensuring the precision of the measurements to be taken.

Therefore there is a need for improvement in the art.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is a block diagram of an embodiment of a test apparatus for a welded thermocouple.

FIG. 2 is a circuit diagram of the test apparatus for welded thermocouple of FIG. 1.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean “at least one.”

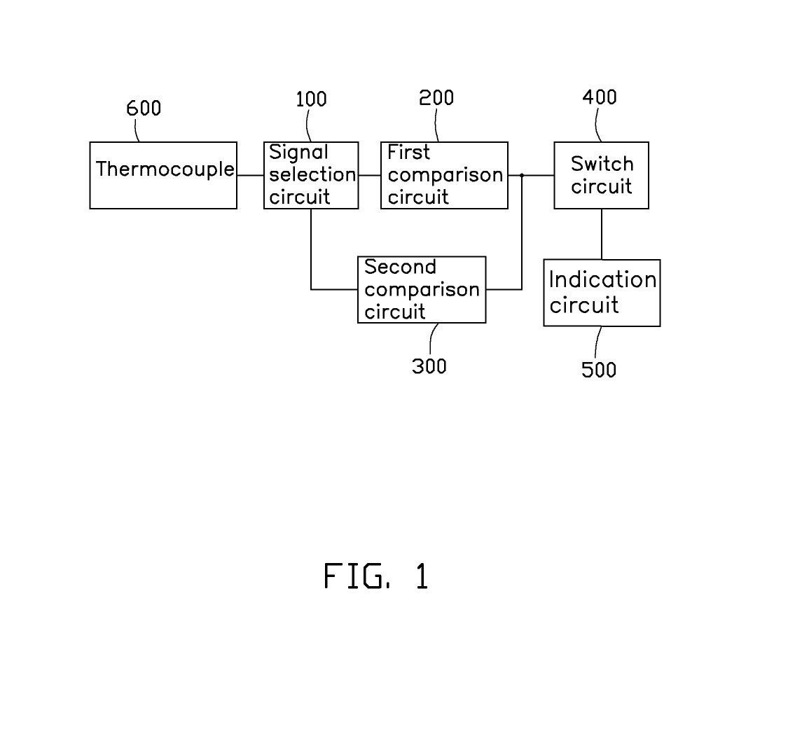

FIG. 1 illustrates a test apparatus for welded thermocouple in accordance with an embodiment. The test apparatus for welded thermocouple tests whether a thermocouple 600 is normally and properly welded. The thermocouple welding test apparatus includes a signal selection circuit 100, a first comparison circuit 200, a second comparison circuit 300, a switch circuit 400 and an indication circuit 500. The signal selection circuit 100 receives a selection signal from a user, and outputs a first direct current (DC) voltage or a second DC voltage according to the selection. The first comparison circuit 200 compares the first DC voltage with a first reference voltage if a first DC voltage is received, to output a first control signal. The second comparison circuit 300 compares the second DC voltage with a second reference voltage if a second DC voltage is received, to output a second control signal. The switch circuit 400 receives the first control signals and the second control signals, and outputs one indication if a first control signal is received, and another indication if a second control signal is received. The indication circuit 500 receives one or the other type of indication, and indicates whether or not the thermocouple 600 is normally and properly welded.

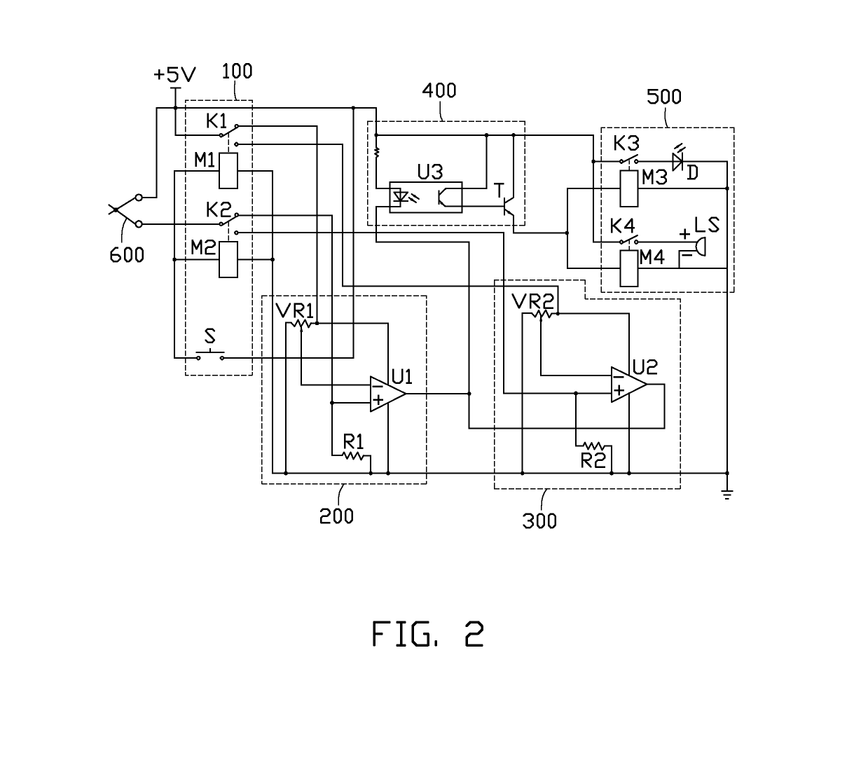

FIG. 2 illustrates a circuit diagram of the thermocouple welding test apparatus in accordance with one embodiment. The signal selection circuit 100 includes a first relay, a second relay, and a pressing button S. The first relay includes a first winding unit M1 and a first switch unit K1. The second relay includes a second winding unit M2 and a second switch unit K2. Each of the first switch unit K1 and the second switch unit K2 includes a first terminal, a second terminal, and a third terminal. The first terminal of the first switch unit K1 is electrically connected to a first terminal of the thermocouple 600 to receive a third DC voltage. The second terminal and the third terminal of the first switch unit K1 are electrically connected to the first comparison circuit 200 and the second comparison circuit 300 respectively to provide working voltages. The first terminal of the second switch unit K2 is electrically connected to a second terminal of the thermocouple 600. The second terminal and the third terminal of the second switch unit K2 output the first DC voltage and the second DC voltage respectively. First terminals of the first winding unit M1 and the second winding unit M2 receive the third DC voltage via the pressing button S. Second terminals of the first winding unit M1 and the second winding unit M2 are grounded. In one embodiment, the third DC voltage is +5V. When the first winding unit M1 is not powered, it is the first terminal and the second terminal of the first switch unit K1 which are electrically connected; and when the first winding unit M1 is powered on, it is the first terminal and the third terminal of the first switch unit K1 which are electrically connected. When the second winding unit M2 is not powered, it is the first terminal and the second terminal of the second switch unit K2 which are electrically connected; and when the second winding unit M2 is powered on, it is the first terminal and the third terminal of the second switch unit K2 which are electrically connected.

The first comparison circuit 200 includes a first comparator U1, a first variable resistor VR1, and a first resistor R1. The second comparison circuit 300 includes a second comparator U2, a second variable resistor VR2, and a second resistor R2. Each of the first comparator U1 and the second comparator U2 includes an inverting input terminal, a non-inverting input terminal, and an output terminal. Each of the first variable resistor VR1 and the second variable resistor VR2 includes a first terminal, a second terminal, and an adjusting terminal. The second terminal and the third terminal of the first switch unit K1 are electrically connected to the first terminals of the first variable resistor VR1 and of the second variable resistor VR2 respectively. The second terminal and the third terminal of the second switch unit K2 are electrically connected to the non-inverting input terminals of the first comparator U1 and of the second comparator U2 respectively. The second terminal and the third terminal of the second switch unit K2 are grounded via the first resistor R1 and via the second resistor R2 respectively. Adjusting terminals of the first variable resistor VR1 and of the second variable resistor VR2 are electrically connected to the inverting input terminals of the first comparator U1 and of the second comparator U2 respectively. Output terminals of the first comparator U1 and the second comparator U2 output a first control signal and a second control signal respectively. In one embodiment, adjusting terminals of the first variable resistor VR1 and the second variable resistor VR2 are positioned on middles of the first variable resistor VR1 and the second variable resistor VR2. A resistance of the first resistor R1 is 100 ohms, and a resistance of the second resistor R2 is 40 ohms.

The switch circuit 400 includes a photocoupler U3 and a transistor T. The photocoupler U3 includes a light emitting element and a light detecting element. An anode of the light emitting element receives the third DC voltage. A cathode of the light emitting element is electrically connected to output terminals of the first comparator U1 and the second comparator U2 to receive either the first control signal or the second control signal. A first terminal of the light detecting element receives the third DC voltage. A second terminal of the light detecting element is electrically connected to a base of the transistor T. A collector of the transistor T also receives the third DC voltage. An emitter of the transistor T outputs one or the other type of indication. In one embodiment, the transistor T is a NPN type transistor.

The indication circuit 500 includes a third relay, a fourth relay, a light emitting diode (LED) D, and a buzzer LS. The third relay includes a third winding unit M3 and a third switch unit K3. The fourth relay includes a fourth winding unit M4 and a fourth switch unit K4. First terminals of the third winding unit M3 and of the fourth winding unit M4 are electrically connected to the emitter of the transistor T to receive one or the other type of indication. Second terminals of the third winding unit M3 and of the fourth winding unit M4 are grounded. First terminals of the third switch unit K3 and of the fourth switch unit K4 receive the third DC voltage. Second terminals of the third switch unit K3 and of the fourth switch unit K4 are electrically connected to anode of the LED D and to the buzzer LS respectively. Cathodes of the LED D and of the buzzer LS are grounded. In one embodiment, the third switch unit K3 and the fourth switch unit K4 are normally-open contact switches.

In a working state, a resistance of the thermocouple 600 is 40-100 ohms when a normally and properly welded thermocouple 600 is connected to the test apparatus. Until the pressing button S is pushed, the first winding unit M1 and the second winding unit M2 do not receive the +5V third DC voltage and are unpowered. The first terminal and the second terminal of the first switch unit K1 are electrically connected. The first terminal and the second terminal of the second switch unit K2 are electrically connected. The +5V third DC voltage provides a working voltage to the first comparator U1. A voltage level at the inverting input terminal of the first comparator U1 is less than a voltage level at the non-inverting input terminal of the first comparator U1. The output terminal of the first comparator U1 outputs a high voltage level first control signal. The light emitting element of the photocoupler U3 is unpowered and emits no light. The light detecting element of the photocoupler U3 detects no light from the light emitting element. The light detecting element is thus off. The base of the transistor T does not receive the +5V third DC voltage. The transistor T is turned off. The third winding unit M3 and the fourth winding unit M4 do not receive the +5V third DC voltage and are unpowered. The third switch unit K3 and the fourth switch unit K4 remain in their normally-open state. Anode of the LED D and of the buzzer LS do not receive the +5V third DC voltage. The LED D emits no light, and the buzzer LS makes no sound.

When the pressing button S is pushed, the first winding unit M1 and the second winding unit M2 receive the +5V third DC voltage. The first terminal and the third terminal of the first switch unit K1 are thus electrically connected. The first terminal and the third terminal of the second switch unit K2 are also electrically connected. The +5V third DC voltage provides a working voltage to the second comparator U2. A voltage level at the inverting input terminal of the second comparator U2 is higher than a voltage level at the non-inverting input terminal of the second comparator U2. The output terminal of the second comparator U2 thus outputs a low voltage level second control signal. The light emitting element of the photocoupler U3 is powered on and emits light. The light detecting element of the photocoupler U3 detects the light and turns on. The base of the transistor T receives the +5V third DC voltage and is turned on. The third winding unit M3 and the fourth winding unit M4 receive the +5V third DC voltage and are powered. The third switch unit K3 and the fourth switch unit K4 are thus closed. Anode of the LED D and of the buzzer LS both receive the +5V third DC voltage, thus the LED D emits light, and the buzzer LS creates an alarm.

When a welded thermocouple 600 with a short circuit is connected to the test apparatus, a resistance of the thermocouple 600 is less than 10 ohms. Until the pressing button S is pushed, the voltage level at the inverting input terminal of the first comparator U1 is less than the voltage level at the non-inverting input terminal of the first comparator U1. The output terminal of the first comparator U1 thus outputs the high voltage level first control signal. The LED D does not emit light, and the buzzer LS makes no sound. When the pressing button S is then pushed, a voltage level at the inverting input terminal of the second comparator U2 is lower than a voltage level at the non-inverting input terminal of the second comparator U2. The output terminal of the second comparator U2 thus outputs a high voltage level second control signal. The LED D does not emit light, and the buzzer LS makes no sound. When a welded thermocouple 600 with an open circuit is connected to the test apparatus, a resistance of the thermocouple 600 becomes infinite. Until the pressing button S is pushed, a voltage level at the inverting input terminal of the first comparator U1 is higher than a voltage level at the non-inverting input terminal of the first comparator U1. The output terminal of the first comparator U1 outputs a low voltage level first control signal. The LED D emits light, and the buzzer LS is activated. When the pressing button S is then pushed, the voltage level at the inverting input terminal of the second comparator U2 is higher than the voltage level at the non-inverting input terminal of the second comparator U2. The output terminal of the second comparator U2 outputs the low voltage level second control signal, thus the LED D again emits light, and the buzzer LS makes a sound.

Even though numerous characteristics and advantages of the present disclosure have been set forth in the foregoing description, together with details of the structure and function of the disclosure, the disclosure is illustrative only, and changes may be made in detail, especially in the matters of shape, size, and arrangement of parts within the principles of the disclosure to the full extent indicated by the broad general meaning of the terms in which the appended claims are expressed.

What is claimed is:

1. A welded thermocouple test apparatus comprising:
a signal selection circuit electrically connected to a thermocouple; wherein the signal selection circuit receives a first selection signal or a second selection signal, and outputs a first direct current (DC) voltage if the first selection signal is received, and a second DC voltage if the second selection signal is received;
a first comparison circuit adapted to compare the first DC voltage with a first reference voltage if a first DC voltage is received and to output a first control signal;
a second comparison circuit adapted to compare the second DC voltage with a second reference voltage if a second DC voltage is received and to output a second control signal;
a switch circuit adapted to receive the first control signals and the second control signals, and output a first alarm signal if the first control signal is received, and a second alarm signal if the second control signal is received; and
an indication circuit adapted to receive the first or the second alarm signal, and output a first indication if the first alarm signal is received, and a second indication if the second alarm signal is received to indicate whether the thermocouple is functioning and properly welded; wherein the thermocouple is functioning and properly welded when a selection signal received by the signal selection circuit changes from the first selection signal to the second selection signal, an indication output by the indication circuit changes from the first indication to the second indication, and vice versa.

2. The welded thermocouple test apparatus of claim 1, wherein the signal selection circuit comprises a first relay, a second relay, and a pressing button; the first relay comprises a first winding unit and a first switch unit; the second relay comprises a second winding unit and a second switch unit; each of the first switch unit and the second switch unit comprises a first terminal, a second terminal, and a third terminal; the first terminal of the first switch unit is electrically connected to a first terminal of the thermocouple to receive a third DC voltage; the second terminal and the third terminal of the first switch unit are electrically connected to the first comparison circuit and the second comparison circuit respectively to provide working voltages; the first terminal of the second switch unit is electrically connected to a second terminal of the thermocouple; the second terminal and the third terminal of the second switch unit output the first DC voltage and the second DC voltage respectively; the first terminals of the first winding unit and the second winding unit receive the third DC voltage via the pressing button; and second terminals of the first winding unit and the second winding unit are grounded.

3. The welded thermocouple test apparatus of claim 2, wherein when the pressing button is not pushed, the signal selection circuit receives a first selection signal; and when the pressing button is pushed, the signal selection circuit receives a second selection signal.

4. The welded thermocouple test apparatus of claim 2, wherein the first comparison circuit comprises a first comparator, a first variable resistor, and a first resistor; the second comparison circuit comprises a second comparator, a second variable resistor, and a second resistor; each of the first comparator and the second comparator comprises an inverting input terminal, a non-inverting input terminal, and an output terminal; each of the first variable resistor and the second variable resistor comprises a first terminal, a second terminal, and an adjusting terminal; the second terminal and the third terminal of the first switch unit are electrically connected to the first terminals of the first variable resistor and the second variable resistor respectively; the second terminal and the third terminal of the second switch unit are electrically connected to the non-inverting input terminals of the first comparator and the second comparator respectively; the second terminal and the third terminal of the second switch unit are grounded via the first resistor and via the second resistor respectively; the adjusting terminals of the first variable resistor and the second variable resistor are electrically connected to the inverting input terminals of the first comparator and the second comparator respectively; and output terminals of the first comparator and the second comparator output a first control signal and a second control signal respectively.

5. The welded thermocouple test apparatus of claim 4, wherein the switch circuit comprises a photocoupler and a transistor; the photocoupler comprises a light emitting element and a light detecting element; an anode of the light emitting element receives the third DC voltage; a cathode of the light emitting element is electrically connected to the output terminals of the first comparator and the second comparator to receive either the first control signal or the second control signal; a first terminal of the light detecting element receives the third DC voltage; a second terminal of the light detecting element is electrically connected to a base of the transistor; a collector of the transistor receives the third DC voltage; and an emitter of the transistor outputs the first or the second alarm signal.

6. The welded thermocouple test apparatus of claim 5, wherein the indication circuit comprises a third relay, a fourth relay, a light emitting diode (LED), and a buzzer; the third relay comprises a third winding unit and a third switch unit; the fourth relay comprises a fourth winding unit and a fourth switch unit; the first terminals of the third winding unit and the of fourth winding unit are electrically connected to the emitter of the transistor to receive the first or the second alarm signal; the second terminals of the third winding unit and the fourth winding unit are grounded; the first terminals of the third switch unit and the fourth switch unit receive the third DC voltage; the second terminals of the third switch unit and the fourth switch unit are electrically connected to an anode of the LED and to an anode of the buzzer respectively; and cathodes of the LED and the buzzer are grounded.

7. The welded thermocouple test apparatus of claim 4, wherein a resistance of the thermocouple is less than an upper limit value, and is greater than a lower limit value when a normally and properly welded thermocouple is connected to the test apparatus; a resistance of the first resistor is equal to the upper limit value; and a resistance of the second resistor is equal to the lower limit value.

8. The welded thermocouple test apparatus of claim 5, wherein the third DC voltage is +5V; and the transistor is a NPN type transistor.

9. A test apparatus for testing whether a welded thermocouple is normally and properly welded, comprising:
a signal selection circuit electrically connected to the thermocouple; wherein the signal selection circuit receives a first selection signal or a second selection signal and outputs a first direct current (DC) voltage if the first selection signal is received, and a second DC voltage if the second selection signal is received;
a first comparison circuit adapted to compare the first DC voltage with a first reference voltage if a first DC voltage is received and to output a first control signal;
a second comparison circuit adapted to compare the second DC voltage with a second reference voltage if a second DC voltage is received and to output a second control signal;
a switch circuit adapted to receive the first control signals and the second control signals, and output a first alarm signal if the first control signal is received, and a second alarm signal if the second control signal is received; and
an indication circuit adapted to receive the first or the second alarm signal, and output a first indication if the first alarm signal is received, and a second indication if the second alarm signal is received to indicate whether or not the thermocouple is functioning and properly welded; wherein the thermocouple is functioning and properly welded when a selection signal received by the signal selection circuit changes from the first selection signal to the second selection signal, an indication output by the indication circuit changes from the first indication to the second indication, and vice versa.

10. The welded thermocouple test apparatus of claim 9, wherein the signal selection circuit comprises a first relay, a second relay, and a pressing button; the first relay comprises a first winding unit and a first switch unit; the second relay comprises a second winding unit and a second switch unit; each of the first switch unit and the second switch unit comprises a first terminal, a second terminal, and a third terminal; the first terminal of the first switch unit is electrically connected to a first terminal of the thermocouple to receive a third DC voltage; the second terminal and the third terminal of the first switch unit are electrically connected to the first comparison circuit and the second comparison circuit respectively to provide working voltages; the first terminal of the second switch unit is electrically connected to a second terminal of the thermocouple; the second terminal and the third terminal of the second switch unit output the first DC voltage and the second DC voltage respectively; the first terminals of the first winding unit and the second winding unit receive the third DC voltage via the pressing button; and second terminals of the first winding unit and the second winding unit are grounded.

11. The welded thermocouple test apparatus of claim 10, wherein when the pressing button is not pushed, the signal selection circuit receives a first selection signal; and when the pressing button is pushed, the signal selection circuit receives a second selection signal.

12. The welded thermocouple test apparatus of claim 10, wherein the first comparison circuit comprises a first comparator, a first variable resistor, and a first resistor; the second comparison circuit comprises a second comparator, a second variable resistor, and a second resistor; each of the first comparator and the second comparator comprises an inverting input terminal, a non-inverting input terminal, and an output terminal; each of the first variable resistor and the second variable resistor comprises a first terminal, a second terminal, and an adjusting terminal; the second terminal and the third terminal of the first switch unit are electrically connected to the first terminals of the first variable resistor and the second variable resistor respectively; the second terminal and the third terminal of the second switch unit are electrically connected to the non-inverting input terminals of the first comparator and the second comparator respectively; the second terminal and the third terminal of the second switch unit are grounded via the first resistor and via the second resistor respectively; the adjusting terminals of the first variable resistor and the second variable resistor are electrically connected to the inverting input terminals of the first comparator and the second comparator respectively; and output terminals of the first comparator and the second comparator output a first control signal and a second control signal respectively.

13. The welded thermocouple test apparatus of claim 12, wherein the switch circuit comprises a photocoupler and a transistor; the photocoupler comprises a light emitting element and a light detecting element; an anode of the light emitting element receives the third DC voltage; a cathode of the light emitting element is electrically connected to the output terminals of the first comparator and the second comparator to receive the either first control signal or the second control signal; a first terminal of the light detecting element receives the third DC voltage; a second terminal of the light detecting element is electrically connected to a base of the transistor; a collector of the transistor receives the third DC voltage; and an emitter of the transistor outputs the first or the second alarm signal.

14. The welded thermocouple test apparatus of claim 13, wherein the indication circuit comprises a third relay, a fourth relay, a light emitting diode (LED), and a buzzer; the third relay comprises a third winding unit and a third switch unit; the fourth relay comprises a fourth winding unit and a fourth switch unit; the first terminals of the third winding unit and of the fourth winding unit are electrically connected to the emitter of the transistor to receive the first or the second alarm signal; the second terminals of the third winding unit and the fourth winding unit are grounded; the first terminals of the third switch unit and the fourth switch unit receive the third DC voltage; the second terminals of the third switch unit and the fourth switch unit are electrically connected to an anode of the LED and to an anode of the buzzer respectively; and cathodes of the LED and the buzzer are grounded.

15. The welded thermocouple test apparatus of claim 12, wherein a resistance of the thermocouple is less than an upper limit value, and is greater than a lower limit value when a normally and properly welded thermocouple is connected to the test apparatus; a resistance of the first resistor is equal to the upper limit value; and a resistance of the second resistor is equal to the lower limit value.

16. The welded thermocouple test apparatus of claim 13, wherein the third DC voltage is +5V; and the transistor is a NPN type transistor.
